(19) United States
(12) Patent Application Publication
(10) Pub. No.: US 2009/0119756 A1
(43) Pub. Date: May 7, 2009

(54) Credential Verification using Credential Repository

(75) Inventors: Victor A. Acuna, Rochester, MN (US); Lee Nee, Rochester, MN (US); Omar E. Perez, Cary, NC (US); Eric K. Wingrove, Rochester, MN (US)

Correspondence Address: MARCIA L. DOUBET LAW FIRM, PO BOX 422859, KISSIMMEE, FL, 34742, US

(73) Assignee: INTERNATIONAL BUSINESS MACHINES CORPORATION, Armonk, NY (US)

(21) Appl. No.: 11/935,407

(22) Filed: Nov. 6, 2007

(51) Int. Cl. H04L 9/32

(52) U.S. Cl. 726/5

(57) ABSTRACT

A credential repository securely stores user credentials. The credential repository may be accessed by multiple entities. Instead of having a user carry his credentials with him (e.g., on a credit card or driver's license, which can be lost or stolen), the user's credentials are retrieved from the credential repository for use in a transaction. A merchant or other entity requesting the transaction receives these retrieved credentials and uses them to verify the identity of the user who seeks to participate in the transaction. A time-to-live value may be associated with the retrieved credentials. Successful verification of the user's identity enables private or personal data of the user to be released to the merchant or other entity. Optionally, the user explicitly authorizes the release of the data.

### BACKGROUND OF THE INVENTION

The present invention relates to computer security, and deals more particularly with using a credential repository for providing credentials for transactions.

Identity theft is a fast-growing concern for citizens living in the so-called “information age”. A tremendous amount of personal data is gathered and stored in repositories around the world, where these repositories are accessible using electronic communications. This personal data may include an individual's financial, medical, legal, and/or business information. Securing this personal data against unauthorized access is of utmost importance. At the same time, it is necessary to have this information available for convenient access by authorized entities.

### BRIEF SUMMARY OF THE INVENTION

The present invention is directed to using a credential repository for providing credentials for transactions. In one aspect, this comprises: storing credentials for a plurality of users in the credential repository; and responsive to receiving a request for credentials of a particular one of the users, determining whether the particular user provided information that authenticates the particular user and if so, retrieving the particular user's credentials from the credential repository and returning the retrieved credentials over a secure communication path to an entity from which the request is received, wherein the returned credentials are adapted to enable the entity to verify an identity of the particular user.

In another aspect, the present invention comprises securing transactions by requesting, from a credential repository that stores credentials of a plurality of users, credentials of a particular user, using an identifier of the particular user and information for authenticating the particular user to the credential repository; responsive to receiving the requested credentials from the credential repository over a secure communication path, using the received credentials to verify an identity of the particular user; and processing a transaction for the particular user if the verification is successful.

Embodiments of these and other aspects of the present invention may be provided as method, systems, and/or computer program products. It should be noted that the foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined by the appended claims, will become apparent in the non-limiting detailed description set forth below.

The present invention will be described with reference to the following drawings, in which like reference numbers denote the same element throughout.

### BRIEF DESCRIPTION OF THE SEVERAL VIEWS OF THE DRAWINGS

FIGS. 1A and 1B illustrate alternative arrangements of entities that may participate in transactions when using embodiments of the present invention;

FIG. 2 provides a flowchart depicting logic which may be used when implementing an embodiment of the present invention;

FIGS. 3A-3F illustrate several graphical user interface (“GUI”) displays that might be provided for interacting with an end user to carry out a transaction, according to an embodiment of the present invention;

FIGS. 4A-4C illustrate sample Extensible Markup Language (“XML”) structured documents that may be exchanged in message flows of a sample transaction, according to an embodiment of the present invention;

FIG. 5 depicts a data processing system suitable for storing and/or executing program code; and

FIG. 6 depicts a representative networking environment in which one or more embodiments of the present invention may be used.

### DETAILED DESCRIPTION OF THE INVENTION

Embodiments of the present invention are directed toward using a credential repository for transactions. This credential repository is preferably independent of merchants and other entities which request access to the credentials stored in the repository. Using techniques disclosed herein, risk of loss due to fraudulent transactions may be lowered.

One of the most common types of identity theft is theft of financial information. Credit card fraud, in particular, is rampant. Credit card information can be easily compromised because of its ease of use and access. As is well known, a common means of verifying the identity of a person attempting to conduct a financial transaction is to inspect the person's signature and/or photograph on a credit card or other identification card (such as a driver's license). Using prior art techniques, the signature provided thereon can be compared to a contemporaneously-provided signature, and the photograph can be compared to the person's current visual appearance.

This existing approach has drawbacks, however. As an example, a person's credit card might be stolen, and the thief might practice writing the signature as shown on the card in order to create a legitimate-looking forgery. As another example, an identification card with the person's photograph might be stolen and altered such that it bears a photograph of the thief. In such situations, a party to whom the forged credit card or identity card is presented may be unable to detect the forgery and will therefore mistakenly believe that the person possessing the card is the legitimate owner. A common result is a fraudulent financial transaction, although other types of fraudulent transactions might occur as well (such as unauthorized access to private information of the card's true owner).

Embodiments of the present invention, by contrast, store user credentials in a readily-accessible yet secure repository. This repository is referred to herein as a “credential repository” or “third-party credential repository” (where “third party” refers to the fact that the credential-verifying entity is neither the merchant nor the customer of the transaction for which credential verification is needed), and the terms “credential service” or “third-party credential service” are used herein to refer to the entity that maintains this repository and provides access to the stored credentials upon request according to procedures disclosed herein.

Because a user's credentials are not stored in or on a personal, user-carried device (such as a credit card with the user's account information stored thereon) when using techniques disclosed herein, the threat of credential forgery by exposure is removed or reduced. Accordingly, the risk of fraudulent transactions involving the user's credentials is lowered. Instead of carrying his credentials, a user according to the present invention preferably carries a device that contains a minimal set of information. By way of example, this device might be a card or phone, and it might contain a customer number (or an alphanumeric string, as another example) that identifies this user for one or more particular types of transactions. Because no credentials (such as a signature, photograph, or credit card number) are contained on the device, loss or theft of the device does not compromise the user's private or personal data.

An embodiment of the present invention may be used with one or more types of transactions. By way of example, transactions involving a person's financial data, medical records, legal records, academic history, and/or business information (referred to equivalently herein as “private” data or “personal” data) may be secured using techniques disclosed herein. In a scenario where medical records are stored in the data repository, for example, a transaction may be directed toward determining whether a user's request to release his medical records can be honored. As another example, a transaction may comprise requesting payment (or payment authorization). Furthermore, a transaction may involve more than one type of private information. A complex transaction might include requesting medical records pertaining to treatment at a physician's office and payment for that treatment, for example. Accordingly, while discussions herein are primarily in terms of a merchant carrying out a purchase transaction for an end user customer, it should be understood that this is by way of illustration and not of limitation.

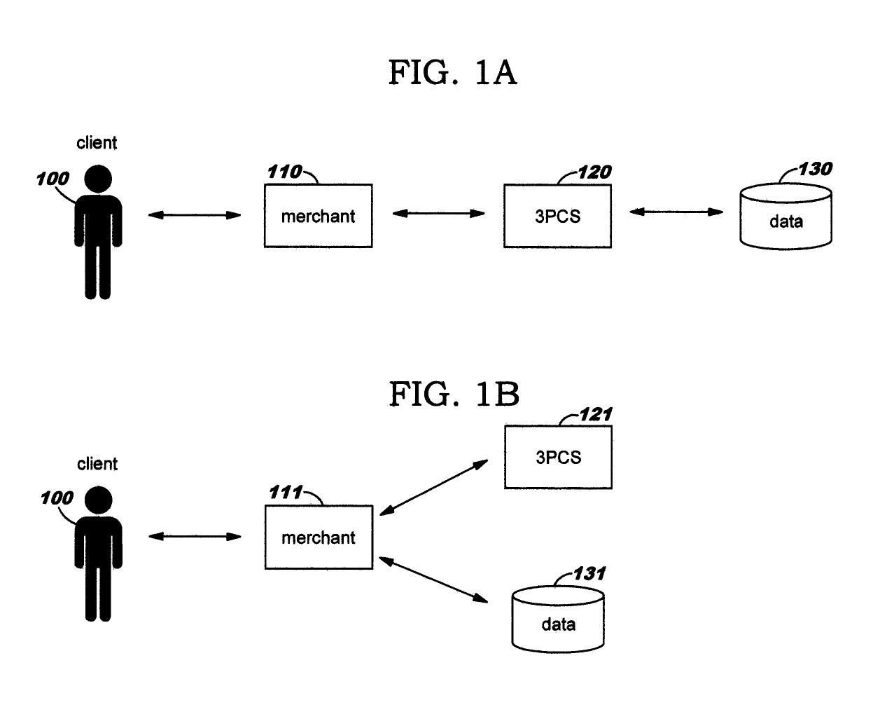

Alternative arrangements of entities that may participate in transactions will now be described, at a high level, with regard to FIGS. 1A and 1B. Further details of these entities, and techniques with which they may interact to carry out secure transactions, will then be described in more detail.

FIG. 1A shows a first sample arrangement whereby an end user (also referred to herein equivalently as a “client” or “customer”) 100 interacts with a merchant system 110. The user might be purchasing goods at a merchant's point-of-sale (“POS”) system, for example, whereby an embodiment of the present invention enables this purchase transaction to be carried out in a secure manner. The merchant system 110 communicates with a third-party credential service (“3PCS”) 120 for authenticating the user. Stored credentials for this user 100 are retrieved by the third-party credential service 120 and provided to the merchant system 110 for verification of the user's identity. If the user's identity is successfully verified, and this verified user authorizes the transaction (where this user authorization may be explicit or implicit, as discussed in more detail below), third-party credential service 120 accesses private data of the user from a data repository 130. Depending on the particular type of transaction, this accessed data may be returned to the merchant system 110. Data repository 130 may be co-located with the third-party credential service 120 (e.g., in a locally-stored database). As one alternative, third-party credential service 120 may contact an independent data provider service, where this data provider service provides secure access to data in repository 130.

FIG. 1B shows a second sample arrangement whereby an end user 100 again interacts with a merchant system 111. In this arrangement, the merchant system 111 is configured to communicate first with a third-party credential service 121 for authenticating the user and obtaining the user's credentials therefrom. The merchant system 111 uses the obtained credentials to verify the identify of the user 100. If the user's identity is successfully verified, and this verified user authorizes the transaction as discussed above, the merchant system 111 communicates directly with a data repository 131 in this arrangement (or with a data provider service, as one alternative, that provides secure access to data in repository 131) to request access to the user's private data.

An embodiment of the present invention uses a secure communication path for communications between the merchant system 110, 111 and the third-party credential service 120, 121 when using the arrangement in either FIG. 1A or FIG. 1B. In addition, an embodiment of the present invention uses a secure communication path for communications between the third-party credential service 120 and an independent data provider service that provides secure access to data in repository 130 according to FIG. 1A, or between merchant system 111 and a data provider that provides secure access to data in repository 131 according to FIG. 1B. For example, mutual authentication procedures (which are outside the scope of the present invention) may be used for establishing these secure communication paths. Risk of fraudulent transactions is further reduced by encrypting data stored in repository 130, 131.

As noted earlier, embodiments of the present invention are not limited to financial or purchase transactions. Accordingly, the terms “merchant” and “merchant system” are used herein by way of illustration but not of limitation. The entity performing functions described herein with reference to a merchant may be more generally referred to as a “requester”, indicating that this entity is requesting credentials for carrying out a transaction. The private data retrieved from data repository 130, 131 is also not limited to use with financial transactions, as stated earlier.

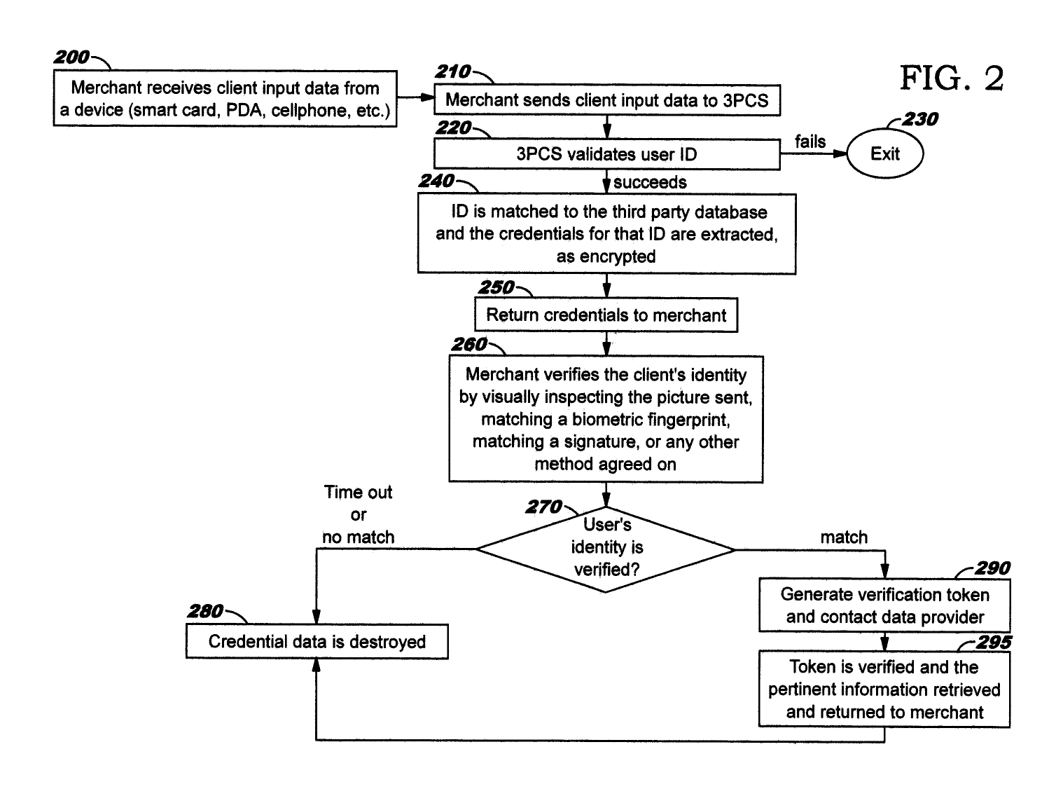

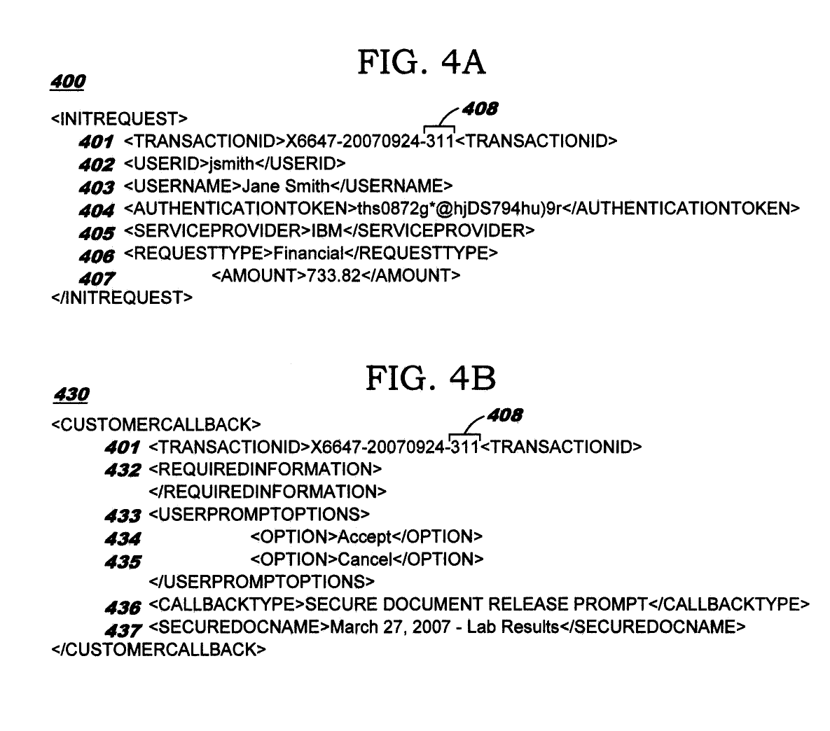

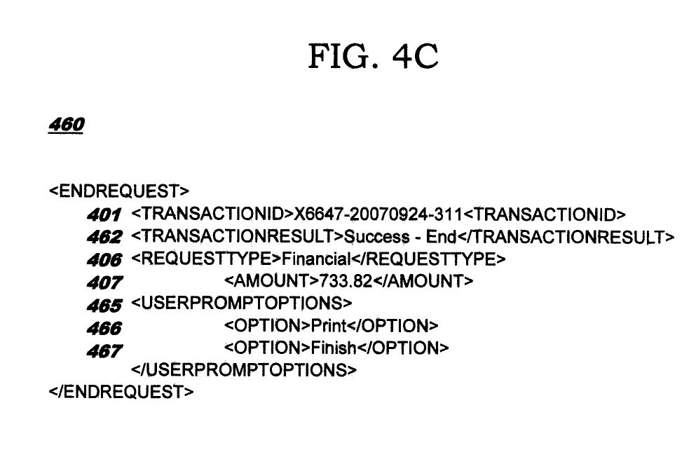

Referring now to FIG. 2, a flowchart shown therein depicts logic which may be used when implementing an embodiment of the present invention. The order in which various processing occurs may vary from one embodiment of the present invention to another. As one example, one embodiment may exchange messages to verify a user's identity before exchanging messages related to the underlying transaction for which the user's identity is being verified. By contrast, in another embodiment, information used to verify the user's identity may be communicated using messages that also specify information usable for the underlying transaction. This latter approach is used below when discussing the logic of FIG. 2. For example, the message 400 that is sent at Block 210 is described as containing information for authenticating the user and also containing information pertaining to the underlying transaction. If it is desirable to exchange messages to verify the user's identity before exchanging messages related to the underlying transaction, by contrast, then an alternative version of message 400 (illustrated in FIG. 4A and discussed below) may be used that contains transaction-related information for an already-verified user, and the sending of this message may be delayed until Block 290 (in which case the message sent at Block 210 provides the information for authenticating the user but does not specify transaction-related details). It will be obvious to one of skill in the art how the processing of FIG. 2, and the format of the exchanged messages, may be adapted to support an alternate approach of this type.

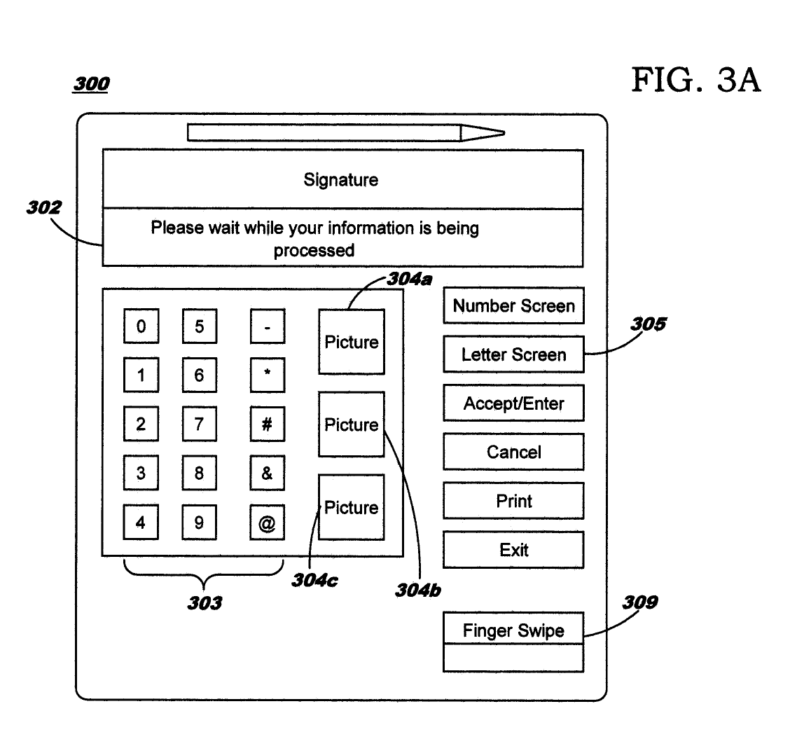

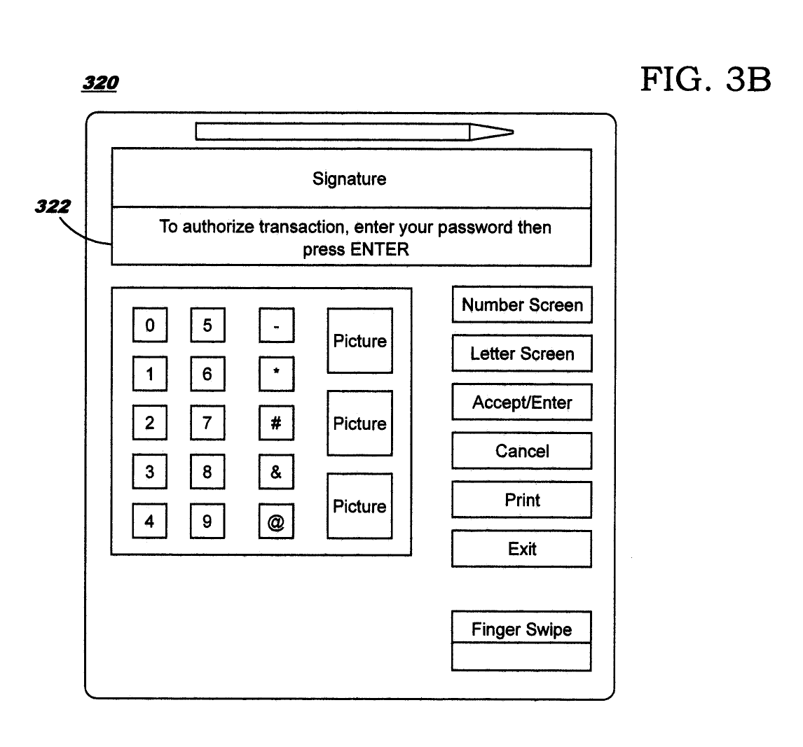

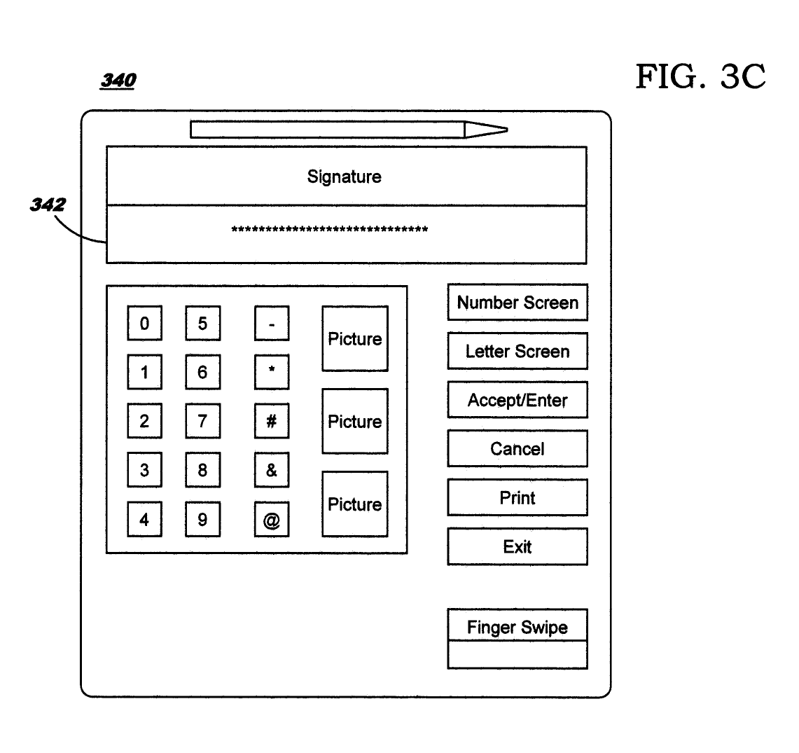

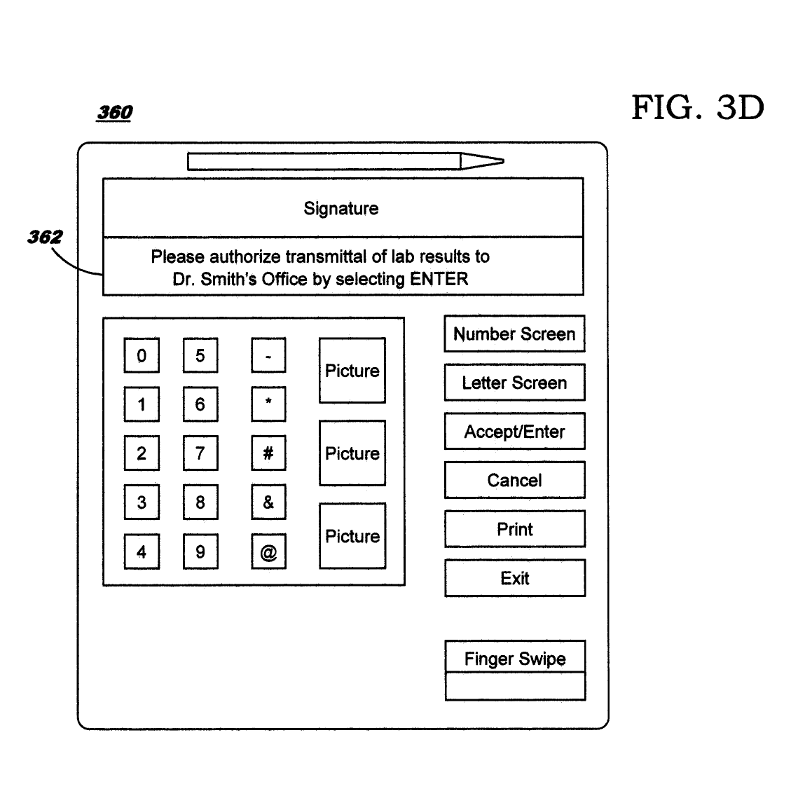

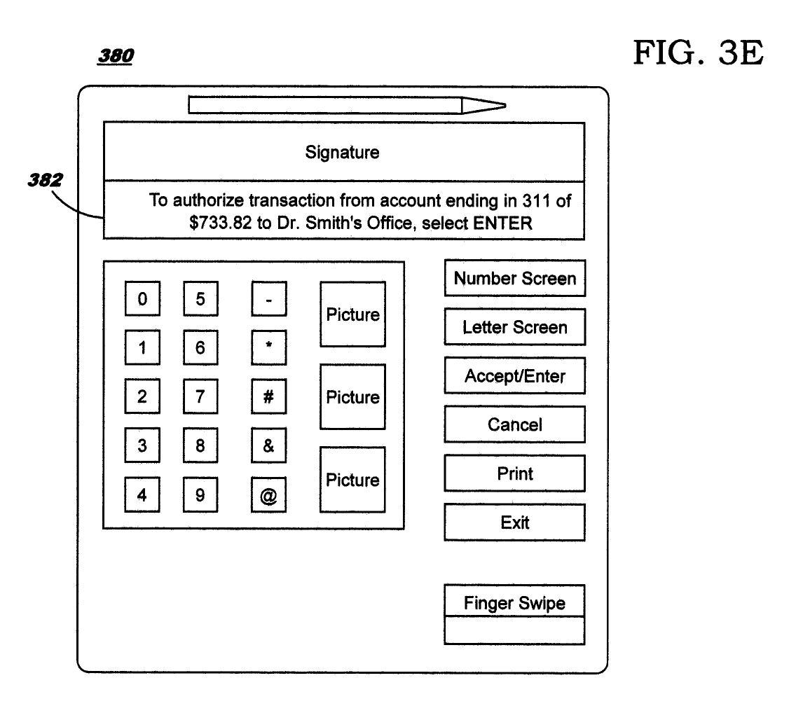

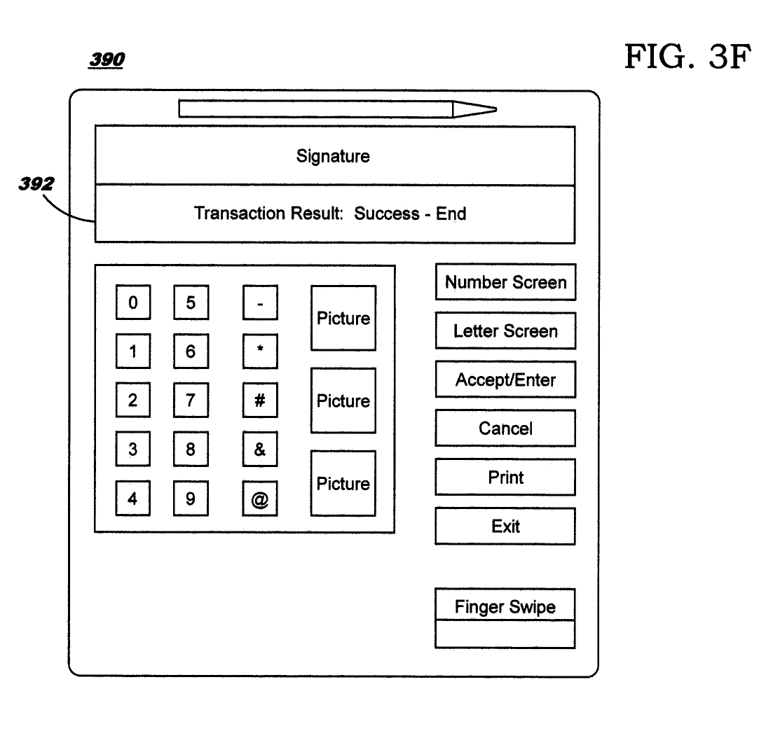

At Block 200, a merchant system receives client input data. This input data may comprise a customer identifier (“ID”)—or more generally, a user ID—embodied on a card, in a cell phone, in a personal digital assistant (“PDA”), in a smart card, in a radio-frequency identification (“RFID”) tag or card, and so forth. In a scenario where a person carries a card containing an ID and presents this card in a purchase transaction, the ID from this card is transmitted to the merchant's POS system (or, equivalently, other transaction-processing system, referred to herein as a merchant system for ease of reference). FIGS. 3A-3F, discussed below, are illustrative of a GUI display with which a user might provide his ID as input for Block 200.

Because the user's ID is not necessarily securely stored, embodiments of the present invention use an authentication token in addition to the user ID (and this authentication token may be obtained at Block 200, in addition to the user ID) to enable the third-party credential service to authenticate the user. The authentication token may comprise (by way of example) a password, personal identification number (“PIN”), biometric data, or other information usable for authenticating the user. The authentication token is sent, along with the user's ID, from the merchant system to the third-party credential service (Block 210).

FIG. 3A provides a sample GUI display 300 that may be provided to a user interacting with an embodiment of the present invention. This display may be rendered on a POS terminal, for example. A message area preferably provides information for the user, and in this case, message 402 is a generic message asking the user to wait while his data is being processed. The user may provide his user ID and/or his authentication token to the merchant system using features of such a display. The ID may be entered, for example, by pressing numbers on keypad 303 (or by selecting key 305 and using a screen of letters displayed in response). Reference number 309 represents a fingerprint scanner that might be used for input of a biometric authentication token. Reference numbers 304a-304c indicate that one or more pictures (or other images, equivalently) may be presented on this GUI display, where these pictures are previously known to the user and thereby provide assurance to the user that the entity presenting the GUI display 300—and capturing the user's input—is the legitimate merchant.

The information sent from the merchant system to the third-party credential service at Block 210 may also comprise a description of the transaction for which the merchant is requesting credentials. As another approach, this transaction-level information may be communicated to the third-party credential service in another manner; for example, the merchant might send a subsequent message (or messages) providing this information. The sample XML document 400 in FIG. 4A illustrates the former approach, as will now be described.

FIG. 4A illustrates an initial request message 400 that triggers processing of a user's credentials for a transaction as disclosed herein. Preferably, message content is encoded in a structured document markup language such as XML (although this is by way of illustration and not of limitation). The initial request message contents shown in sample document 400 comprise, in this example, a transaction identifier 401, a user ID 402, a user name 403, an authorization token 404, a service provider name or ID 405, and a request type 406. In this example, the request type is specified at 406 as “Financial”, and a child element 407 is used to specify an amount of this financial transaction.

Referring again to FIG. 2, the third-party credential service validates the user's identity (Block 220) using the provided user ID (which is illustrated as alphabetic data in sample message 400; see reference number 402) and authentication token. Such validation techniques are known in the art and will not be discussed in detail herein. (As one example, a previously-stored mapping specifies user IDs and their corresponding authentication token, and Block 220 makes a comparison against this stored mapping.)

Validating a user's ID with an authentication token provides a first level of protection against fraudulent transactions, whereby the authentication token is checked to determine whether the person providing the user ID is the person legitimately entitled to have that user ID. If the user's ID card has been stolen, for example, the thief may present the ID from the card but will typically be unable to provide the corresponding authentication token, particularly when the authentication token comprises biometric data.

If the authentication of the user fails, then the processing of FIG. 2 preferably exits, as indicated at Block 230. (As one alternative, error processing may be performed.) If the authentication succeeds, then at Block 240, the authenticated user's credentials are retrieved from the credential repository. These credentials may comprise, for example, a stored image of a person's physical appearance, an image of the person's signature, biometric data (such as a stored image of the person's fingerprint), and/or other forms of identifying information.

Preferably, the user's stored credentials are located in the credential repository by using the authenticated identity of the user. As one example, the user ID provided at Block 200 may be used as an index into a stored ID-to-credential mapping. As another example, a combination of the user ID and authentication token may be used as an index. As a further example, information pertaining to the transaction may be used when forming an index. Referring to the sample request document 400 of FIG. 4A, this information may comprise the service provider value 405, request type 406, and/or some portion of a transaction identifier 401.

Credentials may be stored in the repository in encrypted form, thereby providing another level of protection against fraudulent transactions. As one example, the credentials are encrypted with a key known to the user for whom the credentials are stored, and this user has the decryption key (such as a private key in a security certificate) for decrypting the credentials upon receipt at the merchant.

In one approach, the credentials are returned to the merchant at this point (Block 250). The secure communications used between the merchant and third-party credential service reduce risk of tampering with the credentials while they are in transit. These credentials establish who the person is who is associated with the authenticated identity. The merchant then uses those credentials to verify the user's identity (Block 260). This provides yet another level of protection against fraudulent transactions. If the credentials provide a photograph of the person associated with the authenticated identity, for example, then a clerk or other person at the merchant's location may compare that photograph to the current visual appearance of the user who seeks to participate in the current transaction. Or, if the credentials provide an image of a signature, then the person at the merchant's location may compare that image to a newly-provided signature from the user. User entry of the newly-provided signature is illustrated at 342 in FIG. 3C.

As one alternative to performing the verification by a clerk or other person, automated techniques may be used for verifying the user's identity with the returned credentials. Imaging software, for example, may be used to compare the user's visual appearance to the credentials returned from the third-party credential service, and/or an automated writing recognition technique may be used to evaluate the user's signature. If the credentials provide biometric information, then the user may be asked to provide another biometric sample for comparison. This may comprise, by way of example, swiping his finger across a scanner, depicted at reference number 309 in FIG. 3A.

Block 270 tests whether the user's identity is successfully verified using the returned credentials. Optionally, this test further comprises ensuring that the user's credentials are still valid. Credentials used with an embodiment of the present invention may have an associated time-to-live, or expiration, value associated therewith. This provides a further level of protection against fraudulent transactions (for example, by ensuring that credential information does not persist too long and become usable for verifying an identity when more current information would provide a different result). Accordingly, the “No” branch from Block 270 to Block 280 may be followed when the credential time-to-live value is exceeded or times out, or when the user's identity is not successfully verified for any other reason (such as the user's visual appearance not matching a photograph transmitted from the third-party credential repository). Upon reaching Block 280, the copy of the credential data received by the merchant is preferably destroyed.

The test at Block 270 may further comprise ensuring that the user authorizes completion of the transaction. Referring to the data stored in data repository 130, 131, this authorization signifies that the user approves releasing data therefrom to the merchant requesting the transaction. Authorizing a transaction is discussed in more detail below with reference to FIGS. 3B-3E.

When the test at Block 270 has a successful result, an embodiment of the invention may generate a verification token to indicate the successful verification and forward this verification token to the data provider (which may be the same entity or service as the third-party credential service) as shown at Block 290. In one approach, the merchant system sends this verification token directly to a data provider that provides secure access to data in the data repository (as illustrated in FIG. 1B; see reference numbers 111, 131). In another approach, the merchant system sends the verification token to the third-party credential service, which may then forward the verification token to a data provider that provides secure access to data in the data repository (as illustrated in FIG. 1A; see reference numbers 110, 120, 130).

Upon receiving the verification token, the transaction enters a data retrieval phase where the data provider retrieves the requested information and returns it to the merchant (Block 295). Verification of the token may be performed by the data provider as a prerequisite to returning the information, as noted in Block 295. Data in repository 130, 131 is preferably encrypted while stored. In one approach, the user provides the data for the repository in already-encrypted form. In another approach, the user requests that the data is encrypted at the repository prior to storing. In this approach, the user may provide an encryption key, such as a public key associated with a security certificate. In either of these two approaches, the data is transmitted to the merchant at Block 295 in encrypted form, and the user is then responsible for providing a decryption key. The merchant may prompt the user for this information, for example, using a GUI display similar to those shown in FIGS. 3A-3F. An embodiment of the present invention may optionally also transmit a verification token from the data provider when returning the requested data.

After the requested information is returned to the merchant, control reaches Block 280, where the merchant preferably destroys the credential information as discussed earlier.

In another approach, the initial request message that triggers processing of a transaction (and which is illustrated at 400 of FIG. 4A) is not sent until Block 290 is reached. In this approach, which was discussed prior to the detailed discussion of FIG. 2, the above-described communication of a user's ID and authentication token to the third-party credential service may use a message similar to that of message 400, without identifying a particular type of transaction or providing transaction-related information. Accordingly, the verification token may be provided at 404 when sending message 400 to communicate details of the underlying transaction for the already-verified user.

In yet another approach (also not illustrated in FIG. 2), instead of sending the retrieved data from the data repository to the merchant after the merchant has already verified the user's credentials with information from the third-party credential service, the retrieved data may be sent to the merchant at the same time as the credentials. In this approach, the retrieved data is destroyed (in addition to destroying the credentials as indicated at Block 280) if the verification of the user's credentials is not successful.

The manner in which the data provider determines what information to return at Block 295 may vary from one embodiment of the present invention to another. As one example, a transaction identifier or code provided by the merchant identifies the data of interest. Referring to the sample request document 400 of FIG. 4A, for example, reference number 408 indicates a value “311” within the transaction ID. This value may identify a particular stored account of the user, and the transaction may therefore request return of the information associated with this account. As another example, suppose the transaction involves processing a credit card payment of $500. The initial request message that triggers processing of a user's credentials for a transaction may communicate this information to the third-party credential service (using, for example, request type 406 and amount 407 elements as illustrated in initial request message 400 of FIG. 4A) and a transaction confirmation message (such as message 460 of FIG. 4C, discussed below) is preferably returned to the merchant's system to indicate whether the $500 charge to this person's credit card account is authorized. Information in the initial request message may identify which credit card account should be used. For example, the user may have previously established preferences or similar configuration information where various credit card accounts have associated user-assigned names such as “my cash-back card”, and the request message may use one of these names to identify the user's preferred account. As another approach, the user preferences may specify that a particular card is always to be used for this user's transactions, by default, unless the transaction request overrides this default selection.

Users may implicitly or explicitly authorize completion of transactions. In one approach to implicit authorization, providing the user ID and authentication token at the start of the transaction may be interpreted as the user implicitly authorizing completion of the transaction. In another approach to implicit authorization, an embodiment of the present invention may enable a user to configure preferences that provide a type of pre-authorization. For example, if a particular user always goes to the same medical office, he may set a preference indicating that his explicit authorization is not needed before releasing certain types of private information to this medical office. (Furthermore, an embodiment of the present invention may enable a user to set a preference indicating whether he wants to explicitly authorize all transactions, or transactions of particular types or transactions meeting other criteria.)

In one approach to explicit authorization, a user may explicitly authorize the transaction when it is initiated. GUI display 320 in FIG. 3B may be used to initiate a transaction in this manner, for example, where a message 322 displayed therein asks the user to provide his password and further states that this authorizes the transaction. (Note also that the password obtained from GUI display 320 may also be used as the authentication token to be transmitted to the third-party credential service at Block 210 of FIG. 2.)

In another approach to explicit user authorization of transactions, users may be allowed to explicitly authorize or confirm transactions at an interim stage, as the transactions are in progress. GUI display 320 might be displayed, in one approach, to request this interim authorization (i.e., after the user has already been authenticated). In one embodiment, providing this interim authorization comprises transmitting one or more callback messages from the third-party credential service to the merchant system to request user authorization. Callback messages may also be transmitted to the merchant system to request user input for other purposes. FIG. 4B provides a sample XML document 430 depicting a callback message. Note that this message 430 specifies the same transaction ID value 401 as provided in the initial XML request document 400 of FIG. 4A. This serves to tie the two messages together as part of a single transaction.

In this sample callback message 430, contents thereof further comprise a set of user prompt options 433 (and in this example, indicate that allowable values are “Accept” 434 and “Cancel” 435), a callback type 436, and secure document name 437. In this example, callback type 436 indicates that the callback pertains to prompting the user to authorize release of a secure document, and secure document name 437 indicates that the particular document or data to be released (i.e., from secure storage at a data repository 130, 131) is lab result information from Mar. 27, 2007. Reference number 432 indicates an option (which is not used in this sample transaction) whereby the sender of a callback can specify that particular information is required in response to the message.

In one approach, information from callback message 430 may be used to populate a GUI display with which the user's authorization (or more generally, the user's input) is requested. See FIG. 3D, where a sample GUI display 360 is depicted. As shown therein, message 362 copies information obtained from 436, 437 of callback message 430 in FIG. 4B.

As noted earlier, a sample complex transaction might include requesting medical records pertaining to treatment at a physician's office and payment for that treatment. This is illustrated in FIGS. 3D and 3E. GUI display 360 of FIG. 3D illustrates asking the user (see 362) whether he authorizes transmittal of lab records to Dr. Smith's Office, and GUI display 380 of FIG. 3E asks the user (see 382) whether he authorizes payment of $733.82 to Dr. Smith's Office. This complex transaction may correspond to the transaction request in FIG. 4A. See reference number 407 of FIG. 4A, where the transaction amount for financial transaction 406 is specified as 733.82.

Optionally, a confirmation message may be returned from the data provider and/or the third-party credential service when a transaction completes. A sample confirmation message 460 is shown in FIG. 4C as an XML document. The transaction ID value 401 from the original transaction request 400 is repeated in confirmation message 460. A result indicator 462 is provided, and in this example, states that the transaction was successful and is now ended. Request type 406 and amount 407 are repeated from transaction request 400 (although in some transactions, the amount pertaining to the completed transaction might be different from the amount in the original request). Sample confirmation message 460 further comprise a set of user prompt options 465, and in this example, indicate that allowable values are “Print” 466 and “Finish” 467. See FIG. 3F, depicting a sample GUI display that may be used to communicate the information from confirmation message 460 to the user. (As will be obvious to the reader, the format and contents of a confirmation message may vary from one type of transaction to another, and message 460 is therefore provided by way of illustration but not of limitation.)

Note that it is not strictly necessary that the user is present at the merchant location where the credentials are returned by the third-party credential service. As one alternative, the user and merchant may be communicating online instead of in person, or using other remote communication techniques. As one example, data may be interchanged using a web cam, biometric reader, etc. to authenticate the user with the remotely-located merchant. As another example, an image processing system comprising an imaging device, a processor, a writing recognition peripheral, and other device(s) may be used to enable the repository to be used in transactions of this type. Preferably, secure handshaking techniques are used between all parties.

As will be appreciated by one of skill in the art, embodiments of the present invention may be provided as (for example) methods, systems, and/or computer program products. The invention can take the form of an entirely hardware embodiment, an entirely software embodiment, or an embodiment containing both hardware and software elements. In a preferred embodiment, the invention is implemented in software, which includes (but is not limited to) firmware, resident software, microcode, etc. Furthermore, the present invention may take the form of a computer program product which is embodied on one or more computer-usable storage media (including, but not limited to, disk storage, CD-ROM, optical storage, and so forth) having computer-usable program code embodied therein, where this computer program product may be used by or in connection with a computer or any instruction execution system. For purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (“RAM”), a read-only memory (“ROM”), a rigid magnetic disk, and an optical disk. Current examples of optical disks include compact disk read-only memory (“CD-ROM”), compact disk read/write (“CD-R/W”), and DVD.

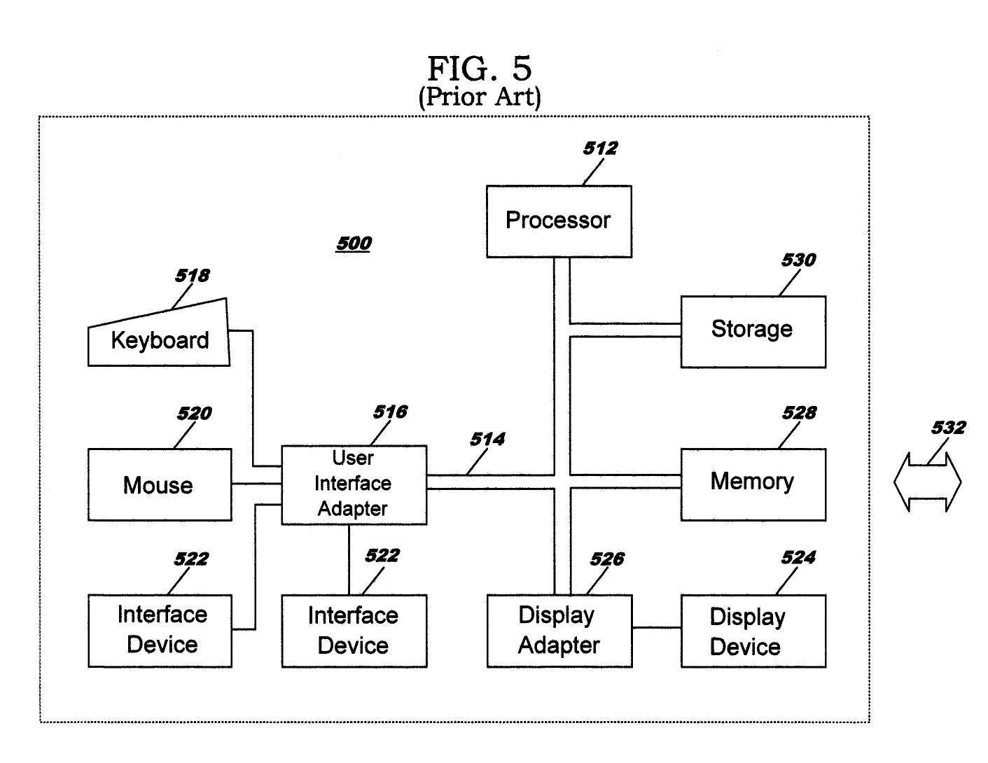

Referring now to FIG. 5, a data processing system 500 suitable for storing and/or executing program code includes at least one processor 512 coupled directly or indirectly to memory elements through a system bus 514. The memory elements can include local memory 528 employed during actual execution of the program code, bulk storage 530, and cache memories (not shown) which provide temporary storage of at least some program code in order to reduce the number of times code must be retrieved from bulk storage during execution.

Input/output (“I/O”) devices (including but not limited to keyboards 518, displays 524, pointing devices 520, other interface devices 522, etc.) can be coupled to the system either directly or through intervening I/O controllers or adapters (516, 526).

Network adapters may also be coupled to the system to enable the data processing system to become coupled to other data processing systems or remote printers or storage devices through intervening private or public networks (as shown generally at 532). Modems, cable modem attachments, wireless adapters, and Ethernet cards are just a few of the currently-available types of network adapters.

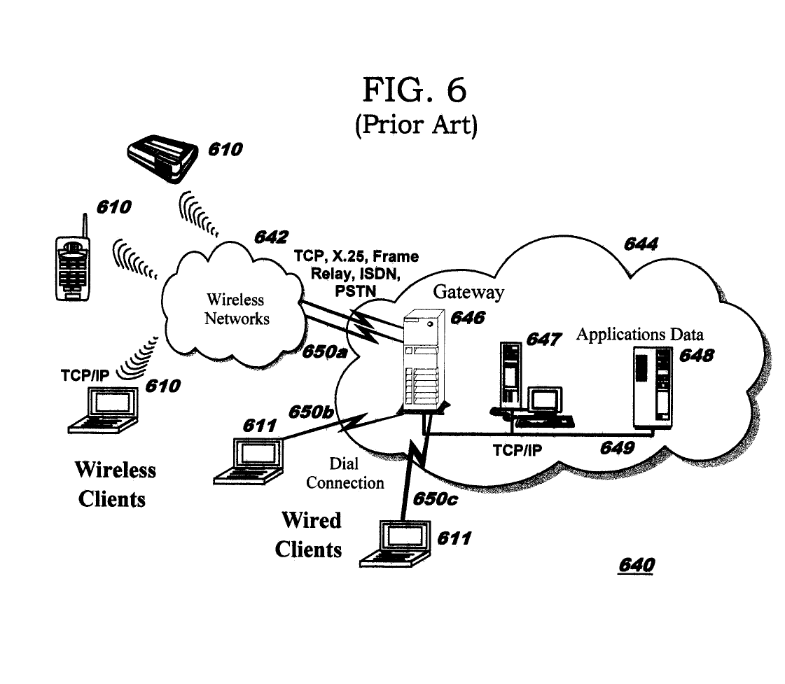

FIG. 6 illustrates a data processing network environment 600 in which the present invention may be practiced. The data processing network 600 may include a plurality of individual networks, such as wireless network 642 and wired network 644. A plurality of wireless devices 610 may communicate over wireless network 642, and a plurality of wired devices, shown in the figure (by way of illustration) as workstations 611, may communicate over wired network 644. Additionally, as those skilled in the art will appreciate, one or more local area networks (“LANs”) may be included (not shown), where a LAN may comprise a plurality of devices coupled to a host processor.

Still referring to FIG. 6, the networks 642 and 644 may also include mainframe computers or servers, such as a gateway computer 646 or application server 647 (which may access a data repository 648). A gateway computer 646 serves as a point of entry into each network, such as network 644. The gateway 646 may be preferably coupled to another network 642 by means of a communications link 650a. The gateway 646 may also be directly coupled to one or more workstations 611 using a communications link 650b, 650c, and/or may be indirectly coupled to such devices. The gateway computer 646 may be implemented utilizing an Enterprise Systems Architecture/390® computer available from IBM. Depending on the application, a midrange computer, such as an Application System/400® (also known as an AS/400®, iSeries®, System i™, and so forth may be employed. (“Enterprise Systems Architecture/390”, “Application System/400”, “AS/400”, and “iSeries” are registered trademarks of IBM in the United States, other countries, or both, and “System i” is a trademark of IBM.)

The gateway computer 646 may also be coupled 649 to a storage device (such as data repository 648).

Those skilled in the art will appreciate that the gateway computer 646 may be located a great geographic distance from the network 642, and similarly, the wireless devices 610 and/or workstations 611 may be located some distance from the networks 642 and 644, respectively. For example, the network 642 may be located in California, while the gateway 646 may be located in Texas, and one or more of the workstations 611 may be located in Florida. The wireless devices 610 may connect to the wireless network 642 using a networking protocol such as the Transmission Control Protocol/Internet Protocol (“TCP/IP”) over a number of alternative connection media, such as cellular phone, radio frequency networks, satellite networks, etc. The wireless network 642 preferably connects to the gateway 646 using a network connection 650a such as TCP or User Datagram Protocol (“UDP”) over IP, X.25, Frame Relay, Integrated Services Digital Network (“ISDN”), Public Switched Telephone Network (“PSTN”), etc. The workstations 611 may connect directly to the gateway 646 using dial connections 650b or 650c. Further, the wireless network 642 and network 644 may connect to one or more other networks (not shown), in an analogous manner to that depicted in FIG. 6.

The present invention has been described with reference to flow diagrams and/or block diagrams according to embodiments of the invention. It will be understood that each flow and/or block of the flow diagrams and/or block diagrams, and combinations of flows and/or blocks in the flow diagrams and/or block diagrams, can be implemented by computer program instructions. These computer program instructions may be provided to a processor of a general purpose computer, special purpose computer, embedded processor, or other programmable data processing apparatus to produce a machine, such that the instructions, which execute via the processor of the computer or other programmable data processing apparatus, create means for implementing the functions specified in the flow diagram flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flow diagram flow or flows and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flow diagram flow or flows and/or block diagram block or blocks.

While embodiments of the present invention have been described, additional variations and modifications in those embodiments may occur to those skilled in the art once they learn of the basic inventive concepts. Therefore, it is intended that the appended claims shall be construed to include the described embodiments and all such variations and modifications as fall within the spirit and scope of the invention.

1. A computer-implemented method of using a credential repository for providing credentials for transactions, comprising:
storing credentials for a plurality of users in the credential repository; and
responsive to receiving a request for credentials of a particular one of the users, determining whether the particular user provided information that authenticates the particular user and if so, retrieving the particular user's credentials from the credential repository and returning the retrieved credentials over a secure communication path to an entity from which the request is received, wherein the returned credentials are adapted to enable the entity to verify an identity of the particular user.

2. The method according to claim 1, further comprising accessing data that pertains to the particular user and that is stored in a data repository, responsive to receiving a notification over the secure communication path that the particular user is successfully verified by the entity using the returned credentials.

3. The method according to claim 2, further comprising returning the accessed data that to the entity over the secure communication path responsive to receiving the notification.

4. The method according to claim 2, wherein the stored data is encrypted for storing in the data repository.

5. The method according to claim 3, wherein the stored data is encrypted for storing in the data repository and the returning returns the data as encrypted.

6. The method according to claim 2, wherein the accessing is performed, responsive to a request from the credential repository, by a data provider that stores the data in the data repository and that is independent of the credential repository.

7. The method according to claim 1, wherein the information that authenticates the particular user comprises one of: a password of the user; a personal identification number of the user; and biometric information of the user.

8. The method according to claim 1, wherein the returned credentials comprise one of: an image of the particular user's physical appearance; an image of the particular user's signature; and previously-stored biometric data for the particular user.

9. A system for using a credential repository for providing credentials for transactions, comprising:
a computer comprising a processor; and
instructions executable using the processor to implement functions comprising:
storing credentials for a plurality of users in the credential repository; and
responsive to receiving a request for credentials of a particular one of the users, determining whether the particular user provided information that authenticates the particular user if so, retrieving the particular user's credentials from the credential repository and returning the retrieved credentials over a secure communication path to an entity from which the request is received, wherein the returned credentials are adapted to enable the entity to verify an identity of the particular user.

10. The system according to claim 9, wherein the functions further comprise accessing data that pertains to the particular user and that is stored in a data repository, responsive to receiving a notification over the secure communication path that the particular user is successfully verified by the entity using the returned credentials.

11. The system according to claim 9, wherein the returned credentials comprise one of: an image of the particular user's physical appearance; an image of the particular user's signature; and previously-stored biometric data for the particular user.

12. A computer program product for using a credential repository for providing credentials for transactions, the computer program product embodied on at least one computer-usable medium and comprising computer-usable program code for:
storing credentials for a plurality of users in the credential repository; and
responsive to receiving a request for credentials of a particular one of the users, determining whether the particular user provided information that authenticates the particular user and if so, retrieving the particular user's credentials from the credential repository and returning the retrieved credentials over a secure communication path to an entity from which the request is received, wherein the returned credentials are adapted to enable the entity to verify an identity of the particular user.

13. The computer program product according to claim 12, further comprising computer-usable program code for accessing data that pertains to the particular user and that is stored in a data repository, responsive to receiving a notification over the secure communication path that the particular user is successfully verified by the entity using the returned credentials.

14. The computer program product according to claim 12, wherein the returned credentials comprise one of: an image of the particular user's physical appearance; an image of the particular user's signature; and previously-stored biometric data for the particular user.
